(19) United States
(12) Patent Application Publication
(10) Pub. No.: US 2016/0366176 A1
(43) Pub. Date: Dec. 15, 2016

(54) HIGH-LEVEL REPUTATION SCORING ARCHITECTURE

(71) Applicant: Northrop Grumman Systems Corporation, Falls Church, VA (US)

(72) Inventor: James E. Bennison, Herndon, VA (US)

(21) Appl. No.: 15/178,827

(22) Filed: Jun. 10, 2016

Related U.S. Application Data
(60) Provisional application No. 62/174,302, filed on Jun. 11, 2015.

(51) Int. Cl. H04L 29/06

(52) U.S. Cl. CPC H04L 63/1441; H04L 63/10; H04L 63/1416

(57) ABSTRACT

A method for improving enterprise network security may include accessing a plurality of reputation scoring sources for a corresponding plurality of reputation scores, determining an aggregate reputation score based on the plurality of reputation scores, and, in response to a domain name service request, generating a response including information indicative of the aggregate reputation score.

### CROSS-REFERENCE TO RELATED APPLICATIONS

This application claims the benefit of U.S. Provisional Application No. 62/174,302, which was filed on Jun. 11, 2015, the entire contents of which are hereby incorporated herein by reference.

### TECHNICAL FIELD

Example embodiments generally relate to online security and, in particular, relate to providing an efficient way of protecting users and systems from accessing Internet domains that have been reported by users to have bad reputations for hosting malicious activity.

### BACKGROUND

The availability and robustness of communication devices and networks to support such devices have made the distribution of content over the Internet a very routine practice. This has also enabled individuals to generate, access and share information with ever increasing ease and efficiency. However, the information shared is not always intended for public consumption, as some information is intended to be protected within government or enterprise networks. Moreover, the Internet can be fertile ground for nefarious activity of various kinds including the creation and distribution of malware that can threaten information security or the ability of devices and networks to function normally.

Accordingly, it may be desirable to define ways to enhance online security.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system that may be useful in connection with generating and using aggregate reputation scores according to an example embodiment;

FIG. 2 illustrates a functional block diagram of an apparatus that may be useful in connection with generating and using aggregate reputation scores according to an example embodiment;

FIG. 3 illustrates a communication system employing aggregate reputation scores in accordance with an example embodiment;

FIG. 4 illustrates lines a method of protecting a network according to an example embodiment; and

FIG. 5 illustrates an example of protocol details for implementing a TXT resource record (RR) in accordance with an example embodiment.

### BRIEF SUMMARY OF SOME EXAMPLES

In accordance with an example embodiment, a method for improving enterprise network security may be provided. The method may include accessing a plurality of reputation scoring sources for a corresponding plurality of reputation scores, determining an aggregate reputation score based on the plurality of reputation scores, and, in response to a domain name service request, generating a response including information indicative of the aggregate reputation score.

In accordance with another example embodiment, a system for improving enterprise network security may be provided. The system may include processing circuitry configured for accessing a plurality of reputation scoring sources for a corresponding plurality of reputation scores, determining an aggregate reputation score based on the plurality of reputation scores, and, in response to a domain name service request, generating a response including information indicative of the aggregate reputation score.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Some example embodiments may enable a reputation score to be generated for various Internet domains based on reports from users or other sources. As an example, a reputation score may be assigned to a uniform resource locator (URL) provided by a commercial or governmental source. The reputations score may be provided to populate a TXT resource record (RR) field in a domain name system (DNS) response that can be used by requesting applications such as Internet filtering gateways, web proxy/gateway systems, a layer in the operating system's transmission control protocol/Internet protocol (TCP/IP) driver stack, or browser plug-ins that can then use the reputation score to enforce policy and block access and/or inform the user that they are potentially entering a risky Internet site.

Currently, reputation scoring solutions are generally network appliances or Windows desktop applications or browser plug-ins, such as McAfee SiteAdvisor, that implement a separate inquiry back to the vendors' proprietary reputation scoring database to get a reputation score and act on such score. The footprint of a particular vendor's proprietary reputation score database is generally fairly limited. Moreover, none of the vendors currently contain intelligence available from the threat indicators shared by the government (which may be classified). Thus, the effectiveness of the end solution provided by typical proprietary solutions is therefore limited. Furthermore, market penetration for currently available solutions is very low, and bandwidth and computing resource utilization is high.

A large number of sites on the Internet are involved in malicious activities such as; exfiltrating data using DNS tunneling, hosting watering holes for downloading spyware and other malware, hosting fraudulent websites that are harvesting log-in credentials as part of phishing schemes, hosting command and control botnet masters, hosting SPAM agents and relays, hosting terrorist recruiting propaganda, etc. Moreover, the five major online search engines, although continuously improving the safety of their search results, still return links to dangerous websites as search results at a rate of approximately four percent. Malicious Internet sites cause virus infections, data breaches, data loss, intellectual property loss, monetary loss, criminal and other activities that cost system owners large sums to prevent, clean up, and recover from. Some example embodiments may provide protection from these malicious activities to reduce the total cost of detection, prevention and recovery activities.

Some example embodiments may employ a reputation scoring database that can incorporate input from governmental and other sources. As such, reputation scoring in an example embodiment may be produced by a source such as the Department of Homeland Security (DHS) and include reputation scores for Internet URLs aggregated from multiple approved sources, which may even include classified government sources, to inject these scores into the DNS response by populating a TXT Resource Record (RR) field in a Domain Name System (DNS) response. That reputation scoring information can then be available to requesting applications (e.g., internet filtering gateways, [transparent] DNS proxies, web proxy/gateways, Internet browsers with plug-ins, O/S TCP/IP stack) which can use the reputation score to enforce policy and/or inform the user that they are potentially entering a risky Internet site.

In an example embodiment, an agent may be provided to execute a software enhancement for DNS security extensions (DNSsec) servers to insert reputation score data in a “TXT” Resource Record. The data fields in the TXT field could also include other data (e.g., the source of the score, the reason for the reputation score, the expiration period (TTL) of the reputation score).

In some cases, example embodiments may enable development of browser “plug-in” software that is configured to, when executed, utilize the reputation score obtained during the DNS request to get the IP address of the web-site to open a pop-up window or display web page warning the user that they are attempting to enter a site with a bad reputation score that could pose a risk. In such examples, the reputation score or/or contextual information about the score such as the reason for the bad score, which may be contained in the TXT field in the DNS response (e.g., the web-site is serving up pornography, the web-site is serving up spyware or malware, the web-site is harvesting log-in credentials, the web-site is exfiltrating data, or the web-site is delivering SPAM) may be displayed or reported to the user.

Another example embodiment may involve development of an enhancement to the software on the Internet gateway (e.g., Internet filtering gateways, [transparent] DNS proxies, web proxy/gateways) at the connection point to an organization's network that would utilize the reputation score, obtained during the DNS request to get the IP address of the web-site. The enhancement, which may be an agent configured to act in accordance with an example embodiment, may be configured to block access to sites with a reputation score that does not comply with the organization's security policy, or warn users of the risk with methods similar to the browser plug-in embodiment described above.

In some embodiments a new system and corresponding method, called DNSSec+RS, may be provided based reputation score generation, distribution and handling. In some cases (e.g., using enhanced DNSsec server(s) with access to a reputation score database), the reputation score may be generated for or provided to an appliance or application on the user end-point that can then utilize the information to protect the end-point system from security compromises by malicious hosts on the Internet.

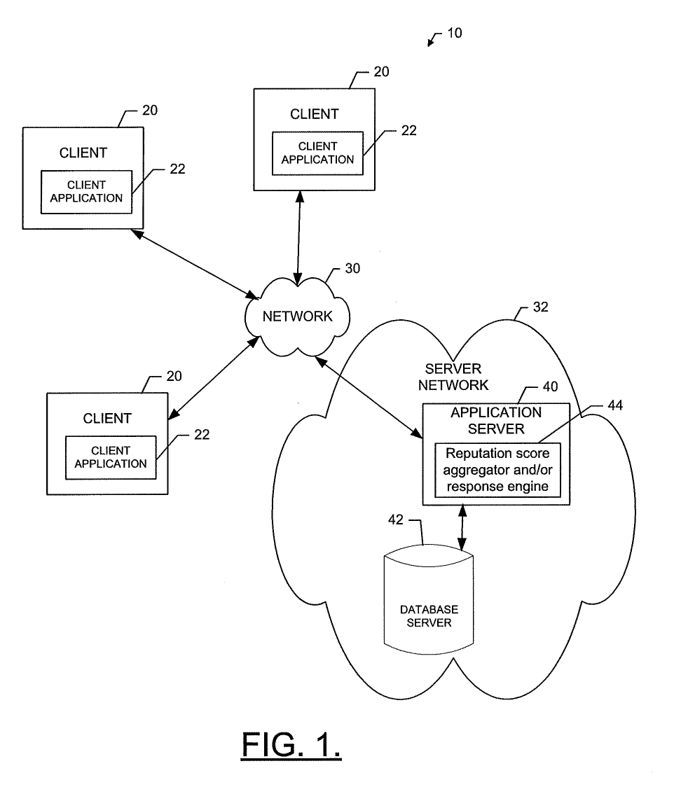

An example embodiment of the invention will now be described in reference to FIG. 1, which illustrates an example system in which an embodiment of the present invention may be employed. As shown in FIG. 1, a system 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the system 10. Furthermore, in some cases, some embodiments may be practiced on a single client without any connection to the system 10.

The example described herein will be related to an asset comprising a computer or analysis terminal to illustrate one example embodiment. However, it should be appreciated that example embodiments may also apply to any asset including, for example, any programmable device that is capable of receiving and analyzing data and information as described herein.

The clients 20 may, in some cases, each be associated with a single organization, department within an organization, or location (i.e., with each one of the clients 20 being associated with an individual analyst of an organization, department or location). However, in some embodiments, each of the clients 20 may be associated with different corresponding locations, departments or organizations. For example, among the clients 20, one client may be associated with a first facility of a first organization and one or more of the other clients may be associated with a second facility of either the first organization or of another organization.

Each one of the clients 20 may include or otherwise be embodied as computing device (e.g., a computer, a network access terminal, a personal digital assistant (PDA), cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30. Moreover, in some embodiments, the information or services that are requested via the network may be provided in a software as a service (SAS) environment. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for processing and/or analyzing DNS requests as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols.

In an example embodiment, devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of access to information and/or services related to operation of the terminals or computers with which the clients 20 are associated. For example, the application server 40 may be configured to provide for storage of information and/or instructions for providing reputation scoring, aggregation of such scores and/or the responses to be taken when requests are received to access information associated with domains having aggregate reputation scores that trigger a response based on a threshold reputation score that may be defined. In some cases, these contents may be stored in the database server 42. Alternatively or additionally, the application server 40 may be configured to provide analytical tools for use by the clients 20 in accordance with example embodiments.

In some embodiments, for example, the application server 40 may therefore include an instance of a reputation score aggregator and/or response engine 44 comprising stored instructions for handling activities associated with practicing example embodiments as described herein. As such, in some embodiments, the clients 20 may access the reputation score aggregator and/or response engine 44 online and utilize the services provided thereby. However, it should be appreciated that in other embodiments, the reputation score aggregator and/or response engine 44 may be provided from the application server 40 (e.g., via download over the network 30) to one or more of the clients 20 to enable recipient clients to instantiate an instance of the reputation score aggregator and/or response engine 44 for local operation. As yet another example, the reputation score aggregator and/or response engine 44 may be instantiated at one or more of the clients 20 responsive to downloading instructions from a removable or transferable memory device carrying instructions for instantiating the reputation score aggregator and/or response engine 44 at the corresponding one or more of the clients 20. In such an example, the network 30 may, for example, be a peer-to-peer (P2P) network where one of the clients 20 includes an instance of the reputation score aggregator and/or response engine 44 to enable the corresponding one of the clients 20 to act as a server to other clients 20.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the reputation score aggregator and/or response engine 44 configured to operate in accordance with an example embodiment of the present invention. In this regard, for example, the reputation score aggregator and/or response engine 44 may include software for enabling the application server 40 to communicate with the network 30 and/or the clients 20 for the provision and/or receipt of information associated with performing activities as described herein. Moreover, in some embodiments, the application server 40 may include or otherwise be in communication with an access terminal (e.g., a computer including a user interface) via which analysts may interact with, configure or otherwise maintain the system 10.

As such, the environment of FIG. 1 illustrates an example in which provision of content and information associated with the analysis such as, for example, security or intelligence operations may be accomplished by a particular entity (namely the reputation score aggregator and/or response engine 44 residing at the application server 40). However, it should be noted again that the reputation score aggregator and/or response engine 44 could alternatively handle provision of content and information within a single organization. Thus, in some embodiments, the reputation score aggregator and/or response engine 44 may be embodied at one or more of the clients 20 and, in such an example, the reputation score aggregator and/or response engine 44 may be configured to handle provision of content and information associated with analytical tasks that are associated only with the corresponding single organization. Access to the reputation score aggregator and/or response engine 44 may therefore be secured as appropriate for the organization involved and credentials of individuals or analysts attempting to utilize the tools provided herein.

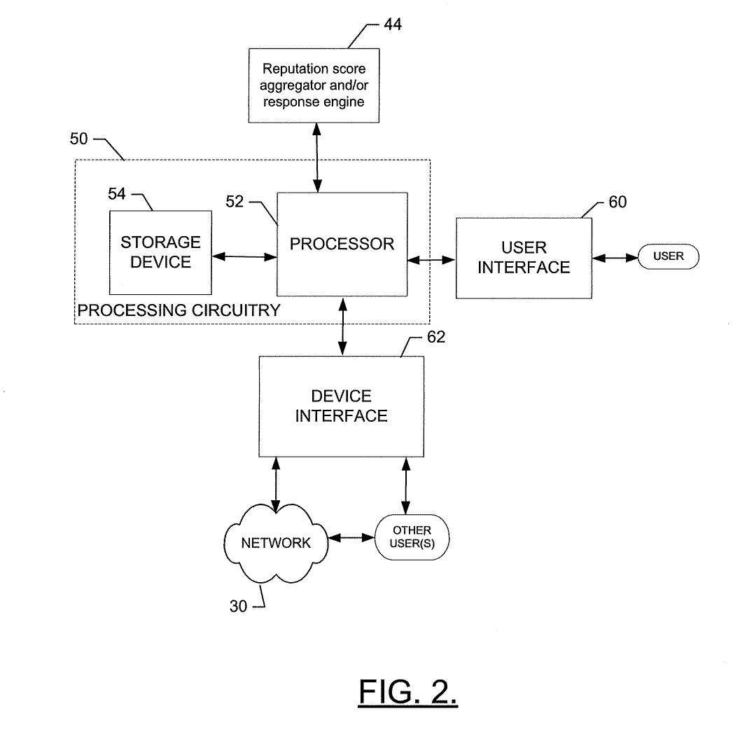

An example embodiment of the invention will now be described with reference to FIG. 2. FIG. 2 shows certain elements of an apparatus for provision of reputation score aggregation and response according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for reputation score aggregation and response is provided. The apparatus may be an embodiment of the reputation score aggregator and/or response engine 44 or a device hosting the reputation score aggregator and/or response engine 44. As such, configuration of the apparatus as described herein may transform the apparatus into the reputation score aggregator and/or response engine 44. In an example embodiment, the apparatus may include or otherwise be in communication with processing circuitry 50 that is configured to perform data processing, application execution and other processing and management services according to an example embodiment of the present invention. In one embodiment, the processing circuitry 50 may include a storage device 54 and a processor 52 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases. Alternatively, as indicated above, the user interface 60 may be remotely located.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or service application 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the reputation score aggregator and/or response engine 44, which may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the reputation score aggregator and/or response engine 44 as described below.

The reputation score aggregator and/or response engine 44 may include tools to facilitate the aggregation of reputation scores generated by reputation scoring sources accessible via the network. The reputation score aggregator and/or response engine 44 may also include tools to facilitate the creation and distribution of analysis results via the network 30. In an example embodiment, the analysis results may include reports indicating risky websites, or a warning relative to a specific access request. The reports may be generated on the basis of analytical processing performed by the reputation score aggregator and/or response engine 44. In this regard, the reputation score aggregator and/or response engine 44 may be configured to process content requests or web addresses to determine an aggregate reputation score (e.g., from multiple sources) to protect network assets. In some embodiments, the aggregate reputation score may be generated in real time in response to a request, or the aggregate reputation scores of many websites may be generated a priori, or a combination of previously and contemporaneously generated aggregate reputation scores may be employed. After the aggregate reputation score is employed, various actions such as blocking access, issuing warnings and/or the like may be taken under the direction of the reputation score aggregator and/or response engine 44.

In some embodiments, the reputation score aggregator and/or response engine 44 may further include one or more components or modules that may be individually configured to perform one or more of the individual tasks or functions generally attributable to the reputation score aggregator and/or response engine 44. However, the reputation score aggregator and/or response engine 44 need not necessarily be modular. In cases where the reputation score aggregator and/or response engine 44 employs modules, one of the modules may, for example, be configured to process reputation scores from multiple sources to generate the aggregate reputation score. Another module may implement responses to aggregate reputation scores such as issuing warnings, blocking access and/or the like. The first module may be at one location in the network 30 and the second module may be at another or the same location.

In some embodiments, the reputation score aggregator and/or response engine 44 and/or any modules comprising the reputation score aggregator and/or response engine 44 may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the reputation score aggregator and/or response engine 44 and/or any modules thereof, as described herein.

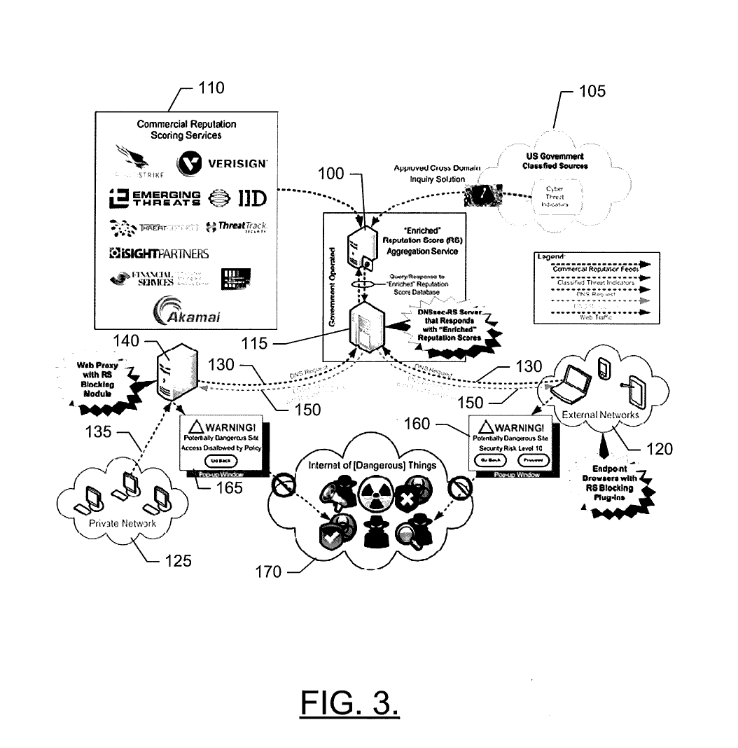

An example embodiment will now be described in general terms in relation to FIG. 3, which shows various data flows of a DNSsec+RS solution of an example embodiment. As can be appreciated from FIG. 3, an enriched reputation score (RS) aggregation service 100 may be provided at a server or device at a government (or enterprise) operated location. The RS aggregation service 100 may employ an instance of the reputation score aggregator and/or response engine 44 of example embodiments. The RS aggregation service 100 may be in communication with (or capable of such communication) one or more government-related cyber threat indication sources 105 and one or more commercial reputation scoring services 110. The RS aggregation service 100 may be configured to generate (e.g., responsive to queries) aggregate reputation scores that can be provided in a database. As such, a DNSsec+RS server 115 may retain “enriched” reputation scores as the aggregate reputation scores.

Devices such as clients 20 associated with external networks 120 or private networks 125 may generate DNS requests 130 to the DNSsec+RS server 115. The DNS requests may come directly from devices of the external networks 120, or may come responsive to web traffic 135 that is routed (e.g., via a web proxy 140) from devices of private networks 125. The DNSsec+RS server 115 may access the aggregate reputation score associated with any request and provide a DNS response with reputation score information 150 in response to the DNS request 130. The DNS response with reputation score information 150 may be used by the web proxy 140 and/or other endpoint devices (e.g., having an instance of the response module of the reputation score aggregator and/or response engine 44) to take action, if appropriate. Action may be appropriate when the aggregate reputation score is above a threshold (or below, depending on the scoring paradigm). Warnings 160 or access blocking may therefore be undertaken to ensure that dangerous aspects or sites 170 accessible via the Internet can be avoided.

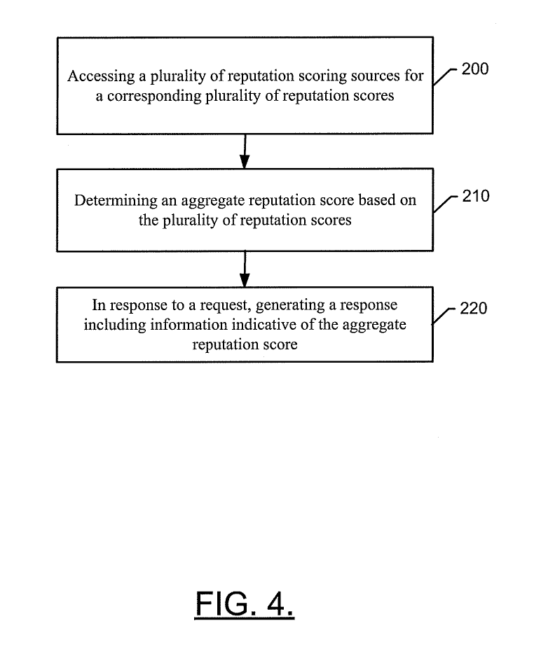

From a technical perspective, the reputation score aggregator and/or response engine 44 described above may be used to support some or all of the operations described above. As such, the platform described in FIG. 2 may be used to facilitate the implementation of several computer program and/or network communication based interactions. As an example, FIG. 4 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, application server 40, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention is shown in FIG. 4. The method may include accessing a plurality of reputation scoring sources for a corresponding plurality of reputation scores at operation 200, determining an aggregate reputation score based on the plurality of reputation scores at operation 210, and, in response to a request, generating a response including information indicative of the aggregate reputation score at operation 220.

In an example embodiment, an apparatus for performing the method of FIG. 4 above may comprise a processor (e.g., the processor 52) or processing circuitry configured to perform some or each of the operations (200-220) described above. The processor may, for example, be configured to perform the operations (200-220) by performing hardware implemented logical functions, executing stored instructions, or executing algorithms for performing each of the operations. In some embodiments, the processor or processing circuitry may be further configured for additional operations or optional modifications to operations 200 to 220. In this regard, for example, the method may further include generating the aggregate reputation score as a weighted average of the plurality of reputation scores. The weighting may be accomplished based on individual confidence levels or weights assigned to specific sources (e.g., based on experience or alignment of interest). In some cases, the method may further include blocking access to a website or issuing a warning relative to access to the website based on the aggregate reputation score.

One advantage that may be provided by some example embodiments is that there is no requirement for an extra query and response across the Internet to get the reputation score from a dedicated database site because it is automatically acquired from within the DNS request/response, which is already necessary to get the IP address associated with a URL. Accordingly, example embodiments may provide improved security with reduced network traffic, delay, and processor load that would otherwise be associated with performing that additional database query.

Example embodiments may also enable systems at the enterprise network perimeter (e.g., Internet screening routers, web-proxies) to enforce organizational policy without the user having the ability to circumvent such enforcement. Some example embodiments may also enable the reputation score protection solution to be implemented at the enterprise network perimeter (e.g., Internet screening routers, web-proxies) to be effective against non-user traffic bound for the Internet such as; malware infected systems exfiltrating data using DNS tunneling, botnet infected hosts beaconing back to their botnet controller, or Trojan malware droppers connecting back to malicious sites to download additional malware.

Another potential advantage of some example embodiments is that the protection is portable. Accordingly, if a protected mobile system with the web-browser plug-in installed is configured to use a reputation scoring DNS server and block dangerous sites it identifies, that protection will work from anyplace in the world where the device is connected.

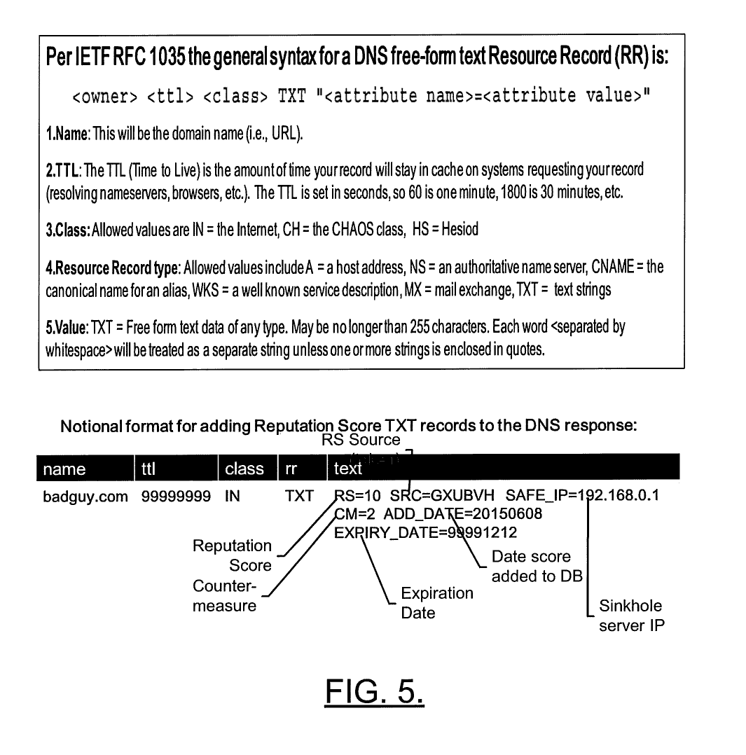

Another potential advantage of some example embodiments is that using the DNSsec protocol for the DNS requests/responses drives adoption of that technology to improve the security of the DNS system to resist DNS spoofing, DNS cache poisoning, and DNS amplification attacks. Example embodiments may also allow the reputation score provider to require client authentication to prevent unauthorized users (e.g., non-paying subscribers) from accessing the reputation scores. FIG. 5 illustrates an example of protocol details for implementing a TXT RR in accordance with an example embodiment

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A system for providing enhanced enterprise network protection, the system comprising processing circuitry configured to:
access a plurality of reputation scoring sources for a corresponding plurality of reputation scores;
determine an aggregate reputation score based on the plurality of reputation scores; and
in response to a domain name service request, generate a response including information indicative of the aggregate reputation score.

2. The system of claim 1, wherein accessing the plurality of reputation scores comprises accessing commercial reputation scoring services.

3. The system of claim 1, wherein accessing the plurality of reputation scores comprises accessing at least one classified governmental source.

4. The system of claim 1, wherein accessing the plurality of reputation scores comprises accessing commercial reputation scoring services and at least one classified governmental source.

5. The system of claim 1, wherein the aggregate reputation score comprises a weighted average of the plurality of reputation scores.

6. The system of claim 1, wherein the processing circuitry is further configured to block access to a website from an organization's network based on the aggregate reputation score.

7. The system of claim 1, wherein the processing circuitry is further configured to issue a warning relative to access to a website based on the aggregate reputation score.

8. The system of claim 1, wherein generating the response including the information indicative of the aggregate reputation score comprises generating the response in response to the aggregate reputation score being above a threshold.

9. The system of claim 1, wherein the information indicative of the aggregate reputation score is provided in a TXT resource record.

10. The system of claim 9, wherein data fields in the TXT resource record further identify a source of the aggregate reputation score, a reason for generating the aggregate reputation score, and an expiration period of the aggregate reputation score.

11. A method for providing enhanced enterprise network protection, the method comprising:
accessing a plurality of reputation scoring sources for a corresponding plurality of reputation scores;
determining an aggregate reputation score based on the plurality of reputation scores; and
in response to a domain name service request, generating a response including information indicative of the aggregate reputation score.

12. The method of claim 11, wherein accessing the plurality of reputation scores comprises accessing commercial reputation scoring services.

13. The method of claim 11, wherein accessing the plurality of reputation scores comprises accessing at least one classified governmental source.

14. The method of claim 11, wherein accessing the plurality of reputation scores comprises accessing commercial reputation scoring services and at least one classified governmental source.

15. The method of claim 11, wherein the aggregate reputation score comprises a weighted average of the plurality of reputation scores.

16. The method of claim 11, further comprising blocking access to a website from an organization's network based on the aggregate reputation score.

17. The method of claim 11, further comprising issuing a warning relative to access to a website based on the aggregate reputation score.

18. The method of claim 11, wherein generating the response including the information indicative of the aggregate reputation score comprises generating the response in response to the aggregate reputation score being above a threshold.

19. The method of claim 11, wherein the information indicative of the aggregate reputation score is provided in a TXT resource record.

20. The method of claim 19, wherein data fields in the TXT resource record further identify a source of the aggregate reputation score, a reason for generating the aggregate reputation score, and an expiration period of the aggregate reputation score.
